(19) United States
(12) Patent Application Publication
(10) Pub. No.: US 2026/0309209 A1
(43) Pub. Date: Oct. 8, 2026

(54) DRIVETRAIN FOR GENERATOR SET, GENERATOR SET, AND METHOD OF PRODUCING DRIVETRAIN FOR GENERATOR SET

(71) Applicant: Cummins Inc., Columbus, IN (US)

(72) Inventors: Neil Graham McNab, Southam (GB); Matthew B. Kenyon, Ramsgate (GB); Alex Edward Priestley, Rugby (GB); Bibhu Batchal Mahanta, Columbus, IN (US)

(73) Assignee: Cummins Inc., Columbus, IN (US)

(21) Appl. No.: 19/708,594

(22) Filed: Jun. 15, 2026

Related U.S. Application Data
(63) Continuation of application No. 19/239,733, filed on Jun. 16, 2025.

(30) Foreign Application Priority Data
Jun. 17, 2024 (GB) 2408650.6

(51) Int. Cl. F16H 1/20; F16H 1/22; F16H 3/097

(52) U.S. Cl. CPC F16H 1/20; F16H 1/22; F16H 3/097

(57) ABSTRACT

A gearbox for a generator includes an input shaft coupled to an input gear, and an output shaft coupled to an output gear. The gearbox further includes a first layshaft coupled to a first pair of splitter gears, where one of the first pair of splitter gears is configured to mesh with the input gear and the other of the first pair of splitter gears is configured to mesh with the output gear. The gearbox also includes a second layshaft coupled to a second pair of splitter gears, where one of the second pair of splitter gears is configured to mesh with the input gear and the other of the second pair of splitter gears is configured to mesh with the output gear.

### CROSS-REFERENCE TO RELATED APPLICATIONS

This application is a continuation of U.S. patent application Ser. No. 19/239,733, filed on Jun. 16, 2025, which claims the benefit of and priority to United Kingdom Application No. 2408650.6, filed on Jun. 17, 2024, the entire disclosure of which is hereby incorporated by reference.

### TECHNICAL FIELD

The present disclosure relates generally to generator sets, and gear systems for generator sets.

### BACKGROUND

A generator set can include an engine and a generator. The generator can be structured to provide power to one or more electric components electrically coupled thereto. The generator can be coupled to the engine via one or more gears, where the gears can transfer power from the engine to the generator.

### SUMMARY

At least one embodiment of the present disclosure relates to a gearbox for a generator. The gearbox includes an input shaft coupled to an input gear and an output shaft coupled to an output gear. The gearbox further includes a first layshaft coupled to a first pair of splitter gears, where one of the first pair of splitter gears is configured to mesh with the input gear and the other of the first pair of splitter gears is configured to mesh with the output gear, and a second layshaft coupled to a second pair of splitter gears, where one of the second pair of splitter gears is configured to mesh with the input gear and the other of the second pair of splitter gears is configured to mesh with the output gear.

In various embodiments, the input shaft and the output shaft are arranged along a first axis, the input shaft being axially spaced from the output shaft. In some embodiments, each of the first layshaft and the second layshaft are arranged parallel to the first axis. In other embodiments, the first layshaft is arranged along a second axis and the second layshaft is arranged along a third axis, where each of the second axis and the third axis is parallel to the first axis. In yet other embodiments, each of the first axis, second axis, and third axis are arranged within a same plane. In various embodiments, a ratio between the input gear and the output gear is 1.2:1. In some embodiments, a maximum allowable twist of at least one of the input shaft, output shaft, first layshaft, or second layshaft is one degree. In other embodiments, a length of each of the first layshaft and the second layshaft is less than a combined length of the input shaft and the output shaft.

Another aspect of the present disclosure relates to a generator set drivetrain for a generator configured to couple to an engine. The generator set drivetrain includes a gearbox structured to transfer power from the engine to the generator. The gearbox includes an input shaft coupled to an input gear and configured to receive an input power, and an output shaft coupled to an output gear and configured to transfer an output power. The gearbox further includes a first layshaft and a second layshaft, where each of the first layshaft and the second layshaft is coupled to a pair of splitter gears, and each of the first layshaft and the second layshaft is arranged parallel to both of the input shaft and the output shaft, and where the input power is split between the first layshaft and the second layshaft.

In various embodiments, the input shaft is in line with the output shaft. In some embodiments, the first layshaft is disposed on a first side of each of the input shaft and the output shaft, and where the second layshaft is disposed on a second side of each of the input shaft and the output shaft, the first side being opposite the second side. In other embodiments, a power received by each of the first layshaft and the second layshaft is between one third and two thirds of the input power. In yet other embodiments, each of the input shaft, output shaft, first layshaft, and second layshaft are arranged in a same plane. In various embodiments, the input power to output power is 1:1.2.

Yet another aspect of the present disclosure relates to a power transfer assembly for transferring power from an engine to a generator. The power supply includes a gearbox configured to transfer power from the engine to the generator. The gearbox includes an input shaft along a first axis, where the input shaft is coupled to an input gear, and an output shaft arranged along the first axis and spaced from the input shaft, the output shaft being coupled to an output gear. The input gear is configured to mesh with a first gear mesh, where the first gear mesh is formed by a first splitter gear and a second splitter gear, where the output gear is configured to mesh with a second gear mesh, the second gear mesh being formed by a first combination gear and a second combination gear, and where the first splitter gear and the first combination gear are coupled to a first shaft and the second splitter gear and the second combination gear are coupled to a second shaft, each of the first shaft and the second shaft being arranged in a same plane as each of the input gear and the output gear.

In various embodiments, a ratio of the output gear to the input gear is less than 1.5:1. In some embodiments, the input gear and the output gear are respectively coupled to the input shaft and the output shaft via a spline connection. In other embodiments, the engine further includes a generator set, the generator set including a generator and an engine, where the gearbox is structured to transfer power from the engine to the generator. In yet other embodiments, the engine receives a gaseous fuel.

Yet another aspect of the present disclosure relates to a method of producing a generator set. The method includes coupling an input gear to an input shaft, coupling an output gear to an output shaft, coupling a first pair of splitter gears to a first layshaft, coupling a second pair of splitter gears to a second layshaft, arranging the first layshaft relative to the input shaft such that a first of the first pair of splitter gears meshes with the input gear and a second of the first pair of splitter gears meshes with the output shaft, arranging the second layshaft relative to the input shaft such that a first of the second pair of splitter gears meshes with the input gear and a second of the second pair of splitter gears meshes with the output gear, and arranging the input shaft to be coaxial with the output shaft.

In various embodiments, coupling the first pair of splitter gears to the first layshaft includes heat shrinking each of the first pair of splitter gears onto the first layshaft, and coupling the second pair of splitter gears to the second layshaft includes heat shrinking each of the second pair of splitter gears onto the second layshaft. In some embodiments, the method further includes determining a length to radius ratio for each of the first layshaft and the second layshaft based on a predetermined amount of allowable twist corresponding to each of the first layshaft and the second layshaft. In other embodiments, the method also includes press fitting a first bearing onto the input shaft, and press fitting a second bearing onto the output shaft. In yet other embodiments, the method also includes press fitting a first pair of bearings onto the first layshaft, and press fitting a second pair of bearings onto the second layshaft. In various embodiments, the method further includes setting a length of each of the input shaft, output shaft, first layshaft, and second layshaft, and determining a radius for each of the input shaft, output shaft, first layshaft, and second layshaft based on a target torque load corresponding to each of the input shaft, output shaft, first layshaft, and second layshaft.

This summary is illustrative only and should not be regarded as limiting.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a side view of a generator set, according to at least one embodiment.

FIG. 2 is a schematic representation of an offset shaft arrangement within the gearbox for the generator set of FIG. 1, according to at least one embodiment.

FIG. 3 is a schematic representation of a side cross-sectional view of a multi-layshaft arrangement the gearbox for the generator set of FIG. 1, according to at least one embodiment.

FIG. 4 is a perspective view of the multi-layshaft arrangement of FIG. 3, according to at least one embodiment.

FIG. 5 is a side view of the multi-layshaft arrangement of FIG. 3, according to at least one embodiment.

FIG. 6 is a top view of the multi-layshaft arrangement of FIG. 3, according to at least one embodiment.

FIG. 7 is a schematic representation of a top cross-sectional view of the multi-layshaft arrangement of FIG. 3, according to at least one embodiment.

FIG. 8 is a perspective view of a multi-layshaft arrangement, according to at least one embodiment.

FIG. 9 is a side view of the multi-layshaft arrangement of FIG. 8, according to at least one embodiment.

FIG. 10 is a perspective view of a multi-layshaft arrangement, according to at least one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments can be utilized, and other changes can be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are contemplated and made part of this disclosure.

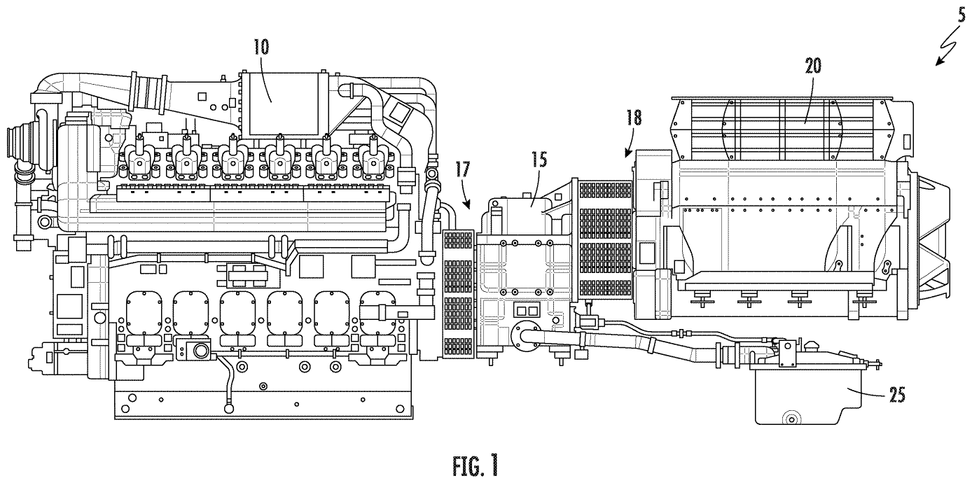

Referring to FIG. 1, a generator set (hereinafter “genset”) 5 is shown, according to at least one embodiment. In various embodiments, the genset 5 includes an engine 10, an engine 20, and a gearbox 15, where the gearbox 15 is structured to transfer power from the engine 10 to the generator 20. In some embodiments, the power can be characterized as a torque, speed, or any other suitable metric known in the art. As shown in FIG. 1, the gearbox 15 can be coupled to the engine 10 at a first end 17 and to the generator 20 at a second end 18. In various embodiments, the engine 10 is a combustion engine structured to receive at least one of a liquid fuel or a gaseous fuel. In some embodiments, the engine 10 is structured to receive a liquid fuel. In other embodiments, the engine 10 is structured to receive a gaseous fuel. In various embodiments, the first end 17 is an input end, where the gearbox 15 can receive an input power. In various embodiments, the second end 18 is an output end, where the gearbox 15 can output an output power. In some embodiments, the genset 5 can also include one or more additional components. For example, as shown in FIG. 1, the genset 5 can also include one or more conduits to provide a flow of fluid (e.g., oil) from a coupled reservoir 25.

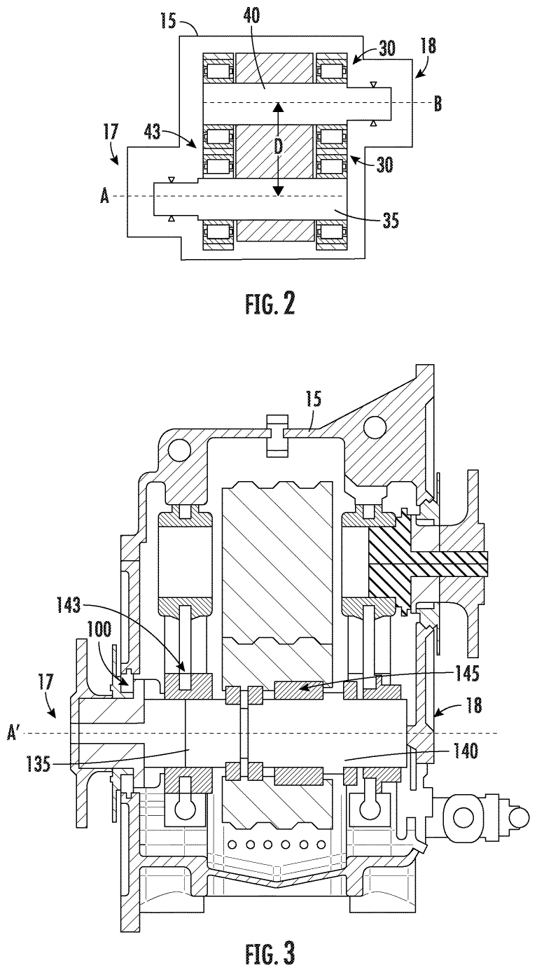

FIG. 2 shows a schematic representation of a side cross-sectional view of the gearbox 15, according to at least one embodiment. As shown in FIG. 2, the gearbox 15 can be structured to include a drivetrain 30, which includes one or more gear meshes to facilitate transferring an input power received at the first end 17 to an output power at the second end 18. The drivetrain 30 can include a first shaft 35 (i.e., an input shaft) and a second shaft 40 (i.e., an output shaft). The first shaft 35 is defined along a first axis, A, which extends parallel to a portion of the first end 17. The second shaft 40 is defined along a second axis, B, which extends parallel to a portion of the second end 18. As shown in FIG. 2, the drivetrain 30 implements an offset configuration in which the second axis, B, corresponding to the second shaft 40 is axially offset by a distance D from the first axis, A, which corresponds to the first shaft 35. The offset configuration provides for the input power received by the first shaft 35 at the first end 17 to be transferred to the second shaft 40 via a first gear mesh 43 and a second gear mesh 45. As shown, the first gear mesh 43 is disposed closer to the first end 17 and the second gear mesh is disposed closer to the second end 18.

Although the offset configuration of the drivetrain 30 can efficiently transfer an input power at the first shaft 35 to an output power at the second shaft 40, the configuration can result in the gearbox 15 having an unduly large footprint within the genset 5 depending on the magnitude of the input/output power and a corresponding gear size necessary to accommodate said power. In some instances, if the distance D is sufficiently large, the genset 5 design can include skid or chassis that is structured to elevate at least a portion of the generator 20 to accommodate the gearbox 15 configuration.

Accordingly, to reduce the footprint of the gearbox 15 within the genset 5, an inline configuration can be used. FIG. 3 shows an inline configuration for a drivetrain 100 within the gearbox 15, where the input shaft 135 is axially aligned with the output shaft 140. As shown, the input shaft 135 and the output shaft 140 are coaxial such that they are aligned along a same axis A′, which extends from the first end 17 of the gearbox 15 to the second end 18 of the gearbox 15. As shown, the drivetrain 100 includes a first gear mesh 143, which is disposed near the first end 17, and a second gear mesh 145, which is disposed near the second end 18. As appreciated from FIG. 3, implementing an inline configuration for the drivetrain 100 reduces an overall size needed for the gearbox 15. Accordingly, although FIG. 3 shows the gearbox 15 being greater in size than the drivetrain 100, the gearbox 15 can be structured so that it is proportionally sized to the drivetrain 100. Furthermore, the multi-layshaft configuration of the drivetrain 100 can allow for transmission of power at comparably lower ratios as compared to the capabilities of other inline gear and shaft configurations (e.g., planetary gears).

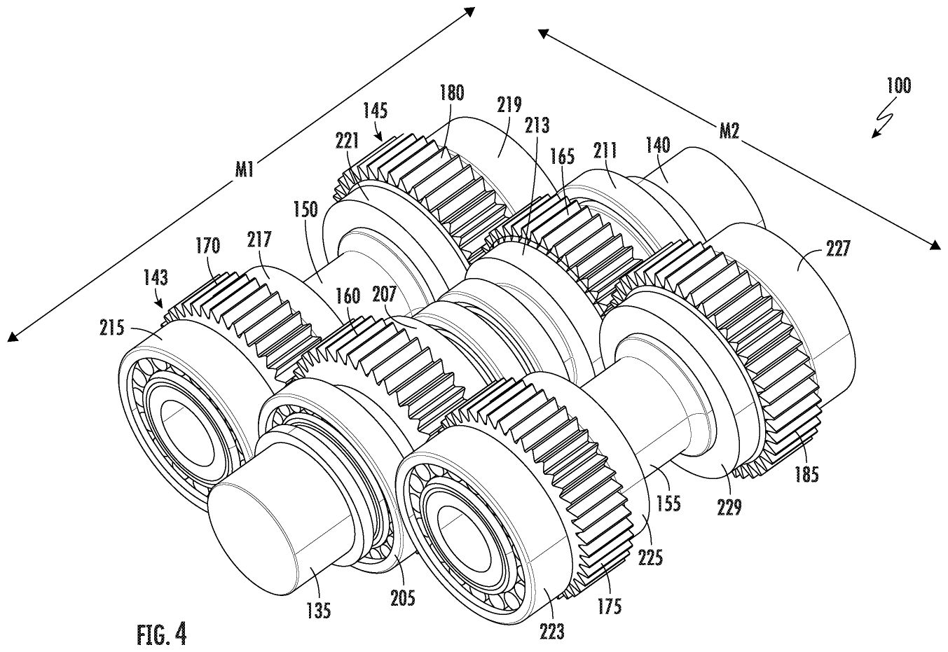

FIG. 4 shows a perspective view of the drivetrain 100, according to at least one embodiment. As described above, the drivetrain 100 can implement an inline configuration in which multiple layshafts are coupled to each of the input shaft 135 and the output shaft 140 to facilitate axial alignment of the input shaft 135 and the output shaft 140. As shown, the drivetrain 100 can include a first splitter shaft or first layshaft 150, which is disposed parallel to each of the input shaft 135 and the output shaft 140. The drivetrain can include a second splitter shaft or second layshaft 155, which is also disposed parallel to each of the input shaft 135 and the output shaft 140. The first layshaft 150 can be disposed on a first side of each of the input shaft 135 and the output shaft 140. The second layshaft 155 can be disposed on a second side of each of the input shaft 135 and the output shaft 140. In various embodiments, the first layshaft 150 and the second layshaft 155 can be arranged on first and second horizonal sides of the input shaft 135 and output shaft 140 such that the drivetrain 100 is arranged in a horizontal plane. In other embodiments, the first layshaft 150 and the second layshaft 155 can be arranged on first and second vertical sides of the input shaft 135 and output shaft 140 such that the drivetrain 100 is arranged in a vertical plane.

As shown, the first layshaft 150 and the second layshaft 155 are coupled to the input shaft 135 via the first gear mesh 143. In various embodiments, the first gear mesh 143 includes an input gear 160, which is disposed on the input shaft 135. The input gear 160 meshes with a first splitter gear 170 disposed on the first layshaft 150 and a second splitter gear 175 (i.e., a first combination gear 175) disposed on the second layshaft 155. Accordingly, power applied to the input shaft 135 (i.e., the input power) can be split from the input shaft 135 between the first layshaft 150 and the second layshaft 155.

As shown, the first layshaft 150 and the second layshaft 155 are coupled to the output shaft 140 via the second gear mesh 145. The second gear mesh 145 includes an output gear 165, which is coupled to the output shaft 140. The output gear 165 meshes with a third splitter gear 180 disposed on the first layshaft 150 and a fourth splitter gear 185 (i.e., a second combination gear 185) disposed on the second layshaft 155. Accordingly, the output shaft 140 is structured to receive power from each of the first layshaft 150 and the second layshaft 155 such that the power transmitted by the output shaft 140 (i.e., the output power) is the sum of both powers from each of the first layshaft 150 and the second layshaft 155.

In various embodiments, the input gear 160 and the output gear 165 can be structured to have a gear ratio that is less than or approximately equal to 1.5:1. In other embodiments, the input gear and the output gear 165 can be structured to have a gear ratio that is less than 1:1.5. In various embodiments, the input gear 160 and the output gear 165 can be structured to have a gear ratio that is less than or approximately equal to 1.2:1. In other embodiments, the input gear and the output gear 165 can be structured to have a gear ratio that is less than or approximately equal to 1:1.2. In various embodiments, the input gear 160 and the output gear 165 can be structured to have a gear ratio that is less than or approximately equal to 0.7:1. In other embodiments, the input gear and the output gear 165 can be structured to have a gear ratio that is less than or approximately equal to 1:0.7.

As shown in FIG. 4, the drivetrain 100 can include a plurality of bearings disposed on one or more of the input shaft 135, output shaft 140, first layshaft 150, and second layshaft 155 to facilitate load support. In various embodiments, the input gear 160 and the output gear 165 can be sandwiched between support bearings. Similarly, in some embodiments, each of the first gear 170, second gear 175, third gear 180, and fourth gear 185 can be disposed or sandwiched between support bearings.

In various embodiments, each of the input shaft 135 and the output shaft 140 can include at least one support bearing. In some embodiments, each of the input shaft 135 and the output shaft 140 can include a pair of support bearings. For example, the input shaft 135 can include a first support bearing 205 on an input side (i.e., closer to the first end 17 of the gearbox 15) of the input gear 160 and a second support bearing 207 on an output side (i.e., closer to the second end 18 of the gearbox 15). Similarly, in some embodiments, the output shaft 140 can include a first support bearing 211 on an output side (i.e., closer to the second end 18 of the gearbox 15) of the output gear 165 and a second support bearing 213 on an input side (i.e., closer to the first end 17 of the gearbox 15).

Each of the first layshaft 150 and the second layshaft 155 can include multiple support bearings. For example, each of the first splitter shaft 150 and the second layshaft 150 can include a pair of support bearings. In some embodiments, each of the first layshaft 150 and the second layshaft 155 can include a pair of support bearings at an input end (i.e., close to the first end 17) and a pair of support bearings at an output end (i.e., close to the second end 18). As shown, the first layshaft 150 can include a first support bearing 215 and a second support bearing 217 disposed on respective input and output sides of the first splitter gear 170. The first layshaft 150 can also include a third support bearing 219 and a fourth support bearing 221 disposed on respective output and input sides of the third splitter gear 180. As shown, the second layshaft 155 can include a first support bearing 223 and a second support bearing 225 disposed on respective input and output sides of the second splitter gear 175. The second layshaft 155 can also include a third support bearing 22 and a fourth support bearing 229 disposed on respective output and input sides of the fourth splitter gear 185.

In various embodiments, one or more dimensions of the drivetrain 100 can be set to accommodate power transmission needs within the genset 5. For example, in various embodiments, the length M1 and/or the width M2 of the drivetrain 100 can be based on a desired distance between the engine 10 and the generator 20. In other embodiments, the length M1 and/or the width M2 of the drivetrain 100 can be determined based on at least one of the input power to be received by the input shaft 135 or the power to be output by the output shaft 140. In various embodiments, the width M2 of the drivetrain 100 can be approximately 1 meter. In other embodiments, the width M2 of the drivetrain 100 can be less than 1 meter. In yet other embodiments, the width M2 of the drivetrain 100 can be approximately 0.8 meters.

In some embodiments, the length M1 can be set based on a desired size of the gearbox 15. For example, to facilitate retaining a small footprint, the size of the gearbox 15 can be minimized, which can result in a corresponding minimization of M1. In some embodiments, a length of the input shaft 135 and/or the output shaft 140 can be set based on the desired length M1 of the drivetrain 100. In various embodiments, the input shaft 135 is axially spaced from the output shaft 140. For example, in some embodiments, a distance between the terminal output end of the input shaft 135 (i.e., the end of the input shaft 135 closer to the second side 18) and the terminal input end of the output shaft 140 (i.e., the end of the output shaft 140 closer to the first side 17) can be set based on the desired length M1. In some embodiments, the distance between the terminal output end of the input shaft 135 and the terminal input end of the output shaft 140 can be minimized. For example, in some embodiments, the distance between the terminal output end of the input shaft 135 and the terminal input end of the output shaft 140 can be less than 0.1 meters. In other embodiments, the distance between the terminal output end of the input shaft 135 and the terminal input end of the output shaft 140 can be approximately zero. In some embodiments, a length of each of the first layshaft 150 and the second layshaft 155 is less than a combined length of the input shaft 135 and the output shaft 140.

In various embodiments, a diameter (e.g., outer diameter) of at least one of the input shaft 135, output shaft 145, first layshaft 150, and second layshaft 155 can be set to accommodate power transmission needs within the genset 5. In various embodiments, the diameter of at least one of the input shaft 135, output shaft 145, first layshaft 150, and second layshaft 155 can be less than 0.5 meters. In some embodiments, the diameter of at least one of the input shaft 135, output shaft 145, first layshaft 150, and second layshaft 155 can be less than approximately 0.4 meters. In yet other embodiments, the diameter of at least one of the input shaft 135, output shaft 145, first layshaft 150, and second layshaft 155 can be approximately 0.3 meters. In some embodiments, the diameter of at least one of the input shaft 135, output shaft 145, first layshaft 150, and second layshaft 155 can be approximately 0.28 meters.

In various embodiments, each of the input shaft 135 and the output shaft 140 can be solid shafts. In some embodiments, each of the first layshaft 150 and the second layshaft 155 can be hollow. In various embodiments, a thickness of each of the first layshaft 150 and the second layshaft 155 can be set based on a desired maximum torsion angle for each of the first layshaft 150 and the second layshaft 155 during transmission of power from the input shaft 135 to the output shaft 140. Similarly, a length of at least one of the input shaft 135, output shaft 145, first layshaft 150, and second layshaft 155 can be determined based on a desired target power load, maximum torsion angle or amount of twist for a corresponding shaft. In various embodiments, the maximum amount of twist is one degree. In some embodiments, the amount of twist can be set based on one of the input power or the output power.

A corresponding length, radius, diameter, and/or thickness for at least one of the input shaft 135, output shaft 145, first layshaft 150, and second layshaft 155 can then be set based on the maximum torsion angle and/or a target power load. In some embodiments, a ratio of length to radius, and/or a ratio of thickness to length for at least one of the input shaft 135, output shaft 145, first layshaft 150, and second layshaft 155 can be set based on the maximum torsion angle and/or a target power. In various embodiments, the length, thickness, or diameter of at least one of the input shaft 135, output shaft 145, first layshaft 150, and second layshaft 155 can be set such that each shaft can resist rotational motion and resist slippage while allowing for power transfer between gears (i.e., input gear 160 and output gear 165), which can have different gear tooth configurations. In various embodiments, the maximum amount of twist (and corresponding dimensions of the shafts within the drivetrain 100) can be based on a predetermined safety factor. In some embodiments, the safety factor can be based on a maximum shear stress within at least one of the input shaft 135, output shaft 145, first layshaft 150, and second layshaft 155.

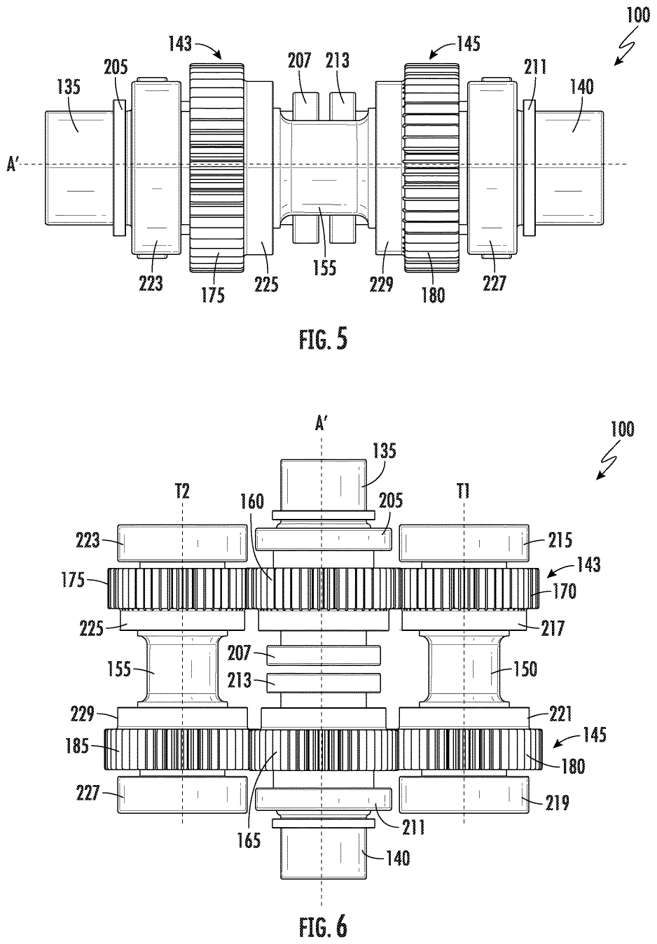

As appreciated from FIGS. 5-6, and as described above, the drivetrain 100 can be structured to be aligned with a single plane. For example, as shown in FIG. 6, the first layshaft 150 can be defined along a first splitter axis T1 and the second layshaft 155 can be defined along a second splitter axis T2. In various embodiments, each of the axes T1 and T2 are substantially parallel to the primary axis A′, along which both of the input shaft 135 and the output shaft 140 are aligned. In various embodiments, the drivetrain 100 can be aligned horizontally within the gearbox 15 such that the first layshaft 150 and the second layshaft 155 are disposed on opposing lateral sides of the input shaft 135 and the output shaft 140. In other embodiments, the drivetrain 100 can be aligned vertically within the gearbox 15 such that the first layshaft 150 and the second layshaft 155 are disposed on opposing vertical sides (i.e., top and bottom) of the input shaft 135 and the output shaft 140.

In various embodiments, a power transfer assembly includes the gearbox 15 configured to transfer power. In some embodiments, the gearbox 15 includes the input shaft 135 along a first axis (e.g., the axis A′), where the input shaft 135 is coupled to the input gear 160, and the output shaft 140 is arranged along the first axis and spaced from the input shaft 135, where the output shaft 140 is coupled to the output gear 165, where the input gear 160 is configured to mesh with the first gear mesh 143, where the first gear mesh 143 is formed by the first splitter gear 170 and the second splitter gear 180, where the output gear is configured to mesh with the second gear mesh 145, the second gear mesh 145 being formed by the first combination gear 175 (i.e., the second splitter gear 175) and the second combination gear 185 (i.e., the fourth splitter gear 185), and where the first splitter gear 170 and the first combination gear 175 are coupled to the first shaft 150 and the second splitter gear 180 and the second combination gear 185 are coupled to the second shaft 155, and where each of the first shaft 150 and the second shaft 155 are arranged in a same plane as each of the input gear 160 and the output gear 165.

In various embodiments, the drivetrain 100 can have a V-type configuration in which both of the layshafts 150, 155 are disposed on a same side of the input shaft 135 and the output shaft 140.

Prior to implementation of the drivetrain 100 within the genset 5, the drivetrain 100 can be constructed by first forming each of the input shaft 135, output shaft 140, first layshaft 150, and second layshafts 155. In various embodiments, shaft formation can be carried out using one or more techniques known in the art including, but not limited to, hot rolling, cold forming, turning and grinding, etc.

Once each of the shafts are formed, each of the gears can be coupled thereto. In various embodiments, each of the input gear 160, output gear 165, first splitter gear 170, second splitter gear 175, third splitter gear 180, and fourth splitter gear 185 can be heat shrunk to couple to the corresponding shaft. For example, each of the input gear 160 and the output gear 165 can be respectively coupled to the input shaft 135 and the output shaft 140 via heat shrinking. Similarly, the first splitter gear 170 and the third splitter gear 180 can be coupled to the first layshaft 150 via heat shrinking. The second splitter gear 175 and the fourth splitter gear 185 can also be coupled to the second layshaft 155 via heat shrinking.

In other embodiments, each of the input gear 160, output gear 165, first splitter gear 170, second splitter gear 175, third splitter gear 180, and fourth splitter gear 185 can be coupled to the corresponding shaft via a splined connection. For example, each of the input gear 160 and the output gear 165 can be respectively coupled to the input shaft 135 and the output shaft 140 via a spline connection. Similarly, the first splitter gear 170 and the third splitter gear 180 can be coupled to the first layshaft 150 via a spline connection. The second splitter gear 175 and the fourth splitter gear 185 can also be coupled to the second layshaft 155 via a spline connection. In yet other embodiments, each of the input gear 160, output gear 165, first splitter gear 170, second splitter gear 175, third splitter gear 180, and fourth splitter gear 185 can be coupled to the corresponding shaft via a keyway connection.

In various embodiments, each of the bearings 205, 207, 215, 217, 219, 221, 223, 225, 227, and 229 can be press-fit to couple to the corresponding shaft. For example, each of the first support bearing 205 and the second support bearing 207 can be coupled to the input shaft 135 via press fitting. Likewise, each of the first support bearing 211 and the second support bearing 213 can be coupled to the output shaft 140 via press fitting. The first support bearing 215 and the second support bearing 217 can be coupled to a first end (i.e., the input end) of the first layshaft 150, and the third support bearing 219 and the fourth support bearing 221 can be coupled to a second end (i.e., the output end) of the first layshaft 150.

In various embodiments, the second support bearing 217 and the fourth support bearing 221 can be first press-fit on to the first layshaft 150 before each of the first splitter gear 170 and the third splitter gear 180 are heat shrunk onto the first layshaft 150. The first support bearing 215 and the third support bearing 219 can then be press-fit onto the first layshaft 150. Similarly, the second support bearing 225 and the fourth support bearing 229 can be first press-fit on to the second layshaft 155 before each of the second splitter gear 175 and the fourth splitter gear 185 are heat shrunk onto the second layshaft 155. The first support bearing 223 and the third support bearing 227 can then be press-fit onto the second layshaft 155.

One each of the bearings and gears have been coupled to their respective shafts, the drivetrain 100 can be lowered into and secured within the gearbox 15. Once coupled to the gearbox 15, the drivetrain 100 can transmit power from the engine 10 at the first end 17 to the generator 20 at the second end 18. It should be noted that although the description above indicates the drivetrain 100 transmits power from the shaft 135 at the first end 17 to the shaft 140 at the second end 18, in various embodiments, the drivetrain 100 can be reversed such that power is transmitted from the shaft 140 to the shaft 135. In this manner, the same drivetrain 100 can be implemented in more than one power transmission environment. For example, the same drivetrain 100 can be used in more than one type of genset 5 by simply reversing the orientation of the drivetrain 100.

In various implementations, a method of producing the generator set 5 includes coupling the input gear 160 to the input shaft 135, coupling the output gear 140 to the output shaft 140, coupling a first pair of splitter gears (i.e., the first splitter gear 170 and the third splitter gear 180) to the first layshaft 150, and coupling a second pair of splitter gears (i.e., the second splitter gear 175 and the fourth splitter 185) to the second layshaft 155. The method also includes arranging the first layshaft 150 relative to the input shaft 135 such that a first of the first pair of splitter gears meshes with the input gear 160 and a second of the first pair of splitter gears meshes with the output shaft 140, arranging the second splitter 155 shaft relative to the input shaft 135 such that a first of the second pair of splitter gears meshes with the input gear 160 and a second of the second pair of splitter gears meshes with the output gear 165, and arranging the input shaft 135 to be coaxial with the output shaft 140.

In various implementations, coupling the first pair of splitter gears (i.e., the first splitter gear 170 and the third splitter gear 180) to the first layshaft 135 includes heat shrinking each of the first pair of splitter gears onto the first layshaft 135, and coupling the second pair of splitter gears (i.e., the second splitter gear 175 and the fourth splitter gear 185) to the second layshaft 155 includes heat shrinking each of the second pair of splitter gears onto the second layshaft 155. In other implementations, coupling the first pair of splitter gears (i.e., the first splitter gear 170 and the third splitter gear 180) to the first layshaft 135 includes coupling each of the first pair of splitter gears onto the first layshaft 135 via a spline or keyway connection, and coupling the second pair of splitter gears (i.e., the second splitter gear 175 and the fourth splitter gear 185) to the second layshaft 155 includes coupling each of the second pair of splitter gears onto the second layshaft 155 via a spline or keyway connection. In some implementations, the method of producing the generator set 5 can include determining a length to radius ratio for each of the first layshaft 150 and the second layshaft 155 based on a predetermined amount of allowable twist corresponding to each of the first layshaft 150 and the second layshaft 155.

In various implementations, the method of producing the generator set 5 can include press fitting the first bearing onto the input shaft 135 and press fitting a second bearing onto the output shaft 140. In various embodiments, the first bearing can be one of the first support bearing 205 or the second support bearing 207. In some embodiments, the second bearing can be one of the first support bearing 211 or the second support bearing 213. In some implementations, the method of producing the generator set can also include press fitting a first pair of bearings onto the first layshaft 150, and press fitting a second pair of bearings onto the second layshaft 155. In various embodiments, the first pair of bearings can include one of the first support bearing 215 or second support bearing 217, and one of the third support bearing 219 or the fourth support bearing 221. Similarly, the second pair of bearings can include one of the first support bearing 223 or the second support bearing 225, and one of the third support bearing 227 or the fourth support bearing 229.

In various implementations, the method of producing the generator set 5 can include setting a length of each of the input shaft 135, output shaft 140, first layshaft 150, and second layshaft 155, and determining a radius for each of the input shaft 135, output shaft 140, first layshaft 150, and second layshaft 155 based on a target power corresponding to each of the input shaft 135, output shaft 140, first layshaft 150, and second layshaft 155.

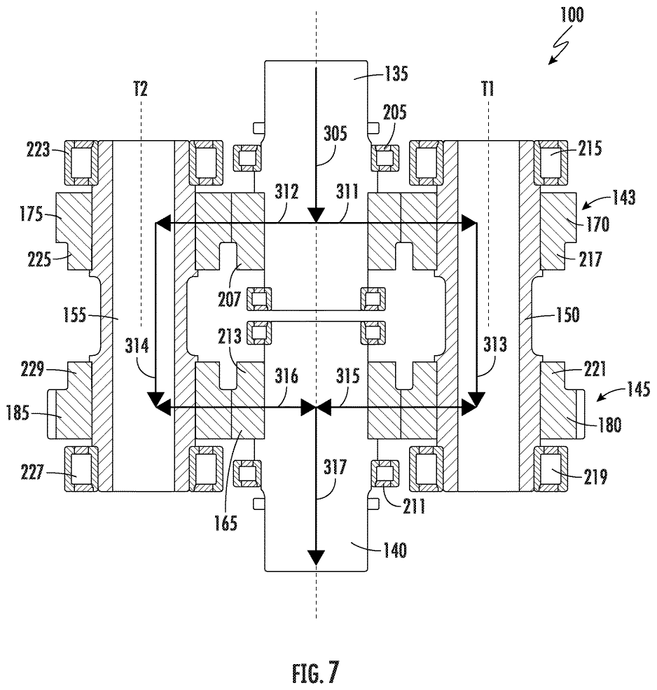

FIG. 7 is a schematic representation of power transmission through the drivetrain 100. As shown, each of the first layshaft 150 and the second layshaft 155 is coupled to a respective pair of splitter gears, where each pair of splitter gears facilitates power transmission along the corresponding first layshaft 150 or the second layshaft 155. Accordingly, as shown in the figures, the first pair of splitter gears can include the first splitter gear 170 and the third splitter gear 180. Similarly, the second pair of splitter gears can include the second splitter gear 175 and the fourth splitter gear 185.

In various embodiments, a gearbox 15 for a generator 20 includes the input shaft 135 coupled to the input gear 160, the output shaft 140 coupled to an output gear 165, the first layshaft 150 coupled to a first pair of splitter gears, wherein one of the first pair of splitter gears (e.g., the first splitter gear 170) is configured to mesh with the input gear 160 and the other of the first pair of splitter gears (e.g., the third splitter gear 180) is configured to mesh with the output gear 165, and the second layshaft 155 coupled to a second pair of splitter gears, wherein one of the second pair of splitter gears (e.g., the second splitter gear 175) is configured to mesh with the input gear 160 and the other of the second pair of splitter gears (e.g., the fourth splitter gear 185) is configured to mesh with the output gear 165.

In some embodiments, the generator set drivetrain 100 for the generator 20 is configured to couple to the engine 10. In various embodiments the generator set drivetrain 100 includes the gearbox 15, which is structured to transfer power from the engine 10 to the generator 20. In some embodiments, the gearbox 15 includes the input shaft 135, which is coupled to the input gear 160 and is configured to receive an input power, the output shaft 140, which is coupled to the output gear 165 and is configured to transfer an output power. The gearbox 15 further includes the first layshaft 150 and the second layshaft 155, where each of the first layshaft 150 and the second layshaft 155 is coupled to a pair of splitter gears (i.e., the first splitter gear 170 and the third splitter gear 180, and the second splitter gear 175 and the fourth splitter gear 185), and each of the first layshaft 150 and the second layshaft 155 arranged parallel to both of the input shaft 135 and the output shaft 140, and where the input power is split between the first layshaft 150 and the second layshaft 155.

As shown, power is received by the input shaft 135, which is indicated as an input power 305. The input power 305 can then be split between the first splitter gear 170 and the second splitter gear 180, as indicated by the respective arrows 311 and 312. The power 311 received by the first splitter gear 170 can then be transmitted along the first layshaft 150 as the first split power 313. Similarly, the power 312 received by the second splitter gear 180 can be transmitted along the second layshaft 155 as the second split power 314.

The first split power 313 and the second split power 314 can be transmitted to the output shaft as indicated by the respective arrows 315 and 316. The resultant output power 317 can then be output via the output shaft 140. Each of the first split power 313 and the second split power 314 can be less than each of the input power 305 and the output power 317. In various embodiments, the input power 305 can be less than the output power 317. In other embodiments, the output power 317 can be less than the input power 305. In various embodiments, each of the first split power 313 and the second split power 314 is between one third and two thirds of the input power 305. In various embodiments, each of the first split power 313 and the second split power 314 is approximately half of the input power 305. In various embodiments, a ratio of the input power 305 to the output power 317 is approximately 1:1.2. In various embodiments, a ratio of the input power 305 to the output power 317 is approximately 1:1.5. In various embodiments, a ratio of the input power 305 to the output power 317 is less than 1:1.5. In various embodiments, a ratio of the input power 305 to the output power 317 is approximately 1:0.7.

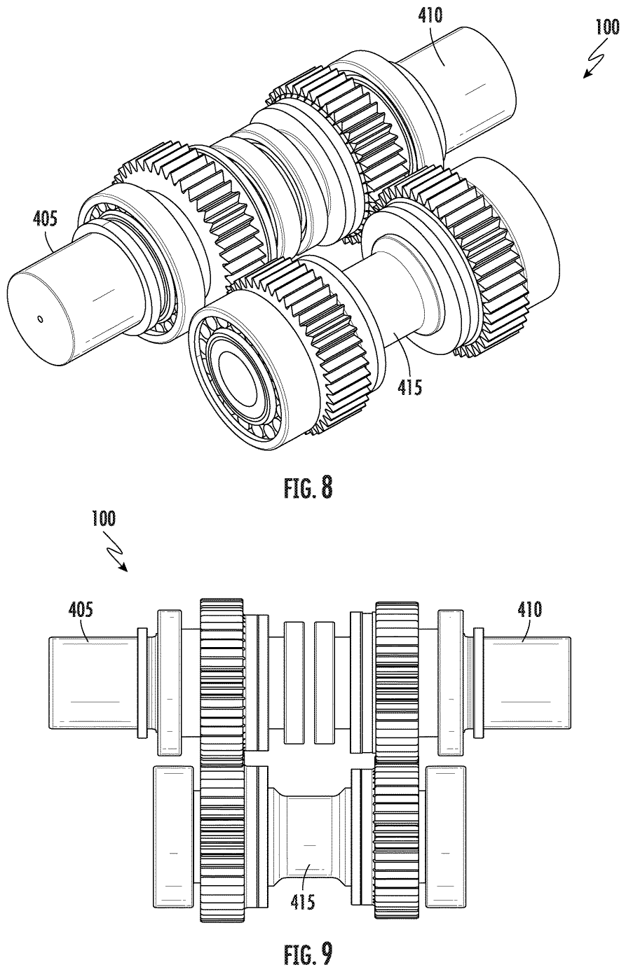

It should be noted that although the description above relates to a multi-layshaft design in which the drivetrain 100 includes two layshafts, in various embodiments, the drivetrain 100 can include any number of layshafts. For example, in some embodiments, the drivetrain 100 can include a single layshaft (e.g., equivalent to the layshaft 150 or the layshaft 155), as shown in FIGS. 8-9. As illustrated, in some embodiments, the drivetrain 100 can include an input shaft 405 (similar or equivalent to the input shaft 135) and an output shaft 410 (similar or equivalent to the output shaft 140). In such embodiments, a layshaft 415 (similar or equivalent to the layshaft 150 to 155), which is structured to engage with each of the input shaft 405 and the output shaft 410, can transfer power from the input shaft 405 to the output shaft 410.

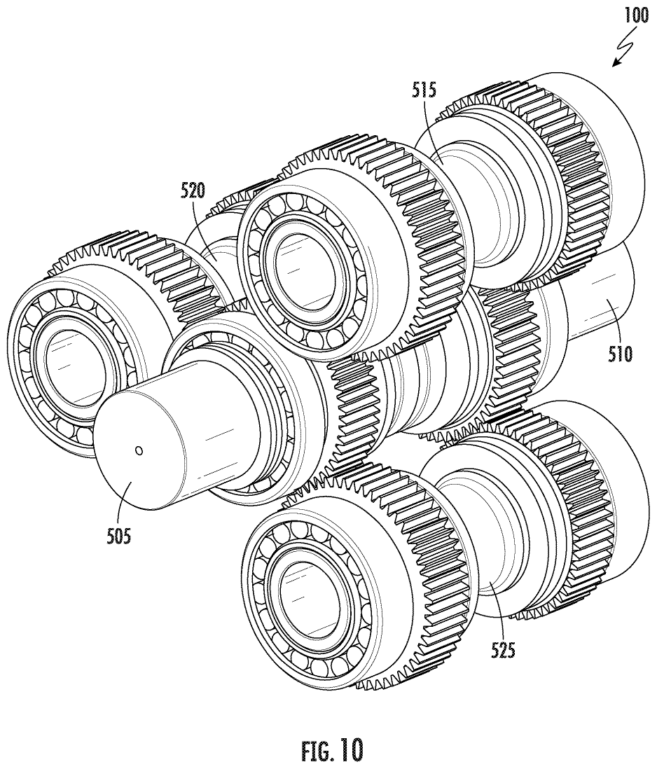

In yet other embodiments, the drivetrain can include three layshafts. As shown in FIG. 10, the drivetrain 100 can include an input shaft 505 (similar or equivalent to the input shaft 135) and an output shaft 510 (similar or equivalent to the output shaft 140). Each of the input shaft 505 and the output shaft 510 can be structured to engage with a first layshaft 515, a second layshaft 520, and a third layshaft 525. Accordingly, in such embodiments, an input power received by the input shaft 505 can be split among the first layshaft 515, second layshaft 520, and third layshaft 525 and transferred to the output shaft 510. Each of the first layshaft 515, second layshaft 520, and third layshaft 525 can be structured to be similar or equivalent to the layshaft 150 or 155. In various embodiments, the drivetrain 100 can include more than three layshafts.

Notwithstanding the embodiments described above in reference to FIGS. 1-10, various modifications and inclusions to those embodiments are contemplated and considered within the scope of the present disclosure.

The present technology may also include, but is not limited to, the features and combinations of features recited in the following lettered paragraphs, it being understood that the following paragraphs should not be interpreted as limiting the scope of the claims as appended hereto or mandating that all such features must necessarily be included in such claims:
A. A gearbox for a generator, the gearbox comprising:
   an input shaft coupled to an input gear;
   an output shaft coupled to an output gear;
   a first layshaft coupled to a first pair of splitter gears, wherein one of the first pair of splitter gears is configured to mesh with the input gear and the other of the first pair of splitter gears is configured to mesh with the output gear; and
   a second layshaft coupled to a second pair of splitter gears, wherein one of the second pair of splitter gears is configured to mesh with the input gear and the other of the second pair of splitter gears is configured to mesh with the output gear.
B. The gearbox of paragraph A, wherein the input shaft and the output shaft are arranged along a first axis, the input shaft being axially spaced from the output shaft.
C. The gearbox of claim of paragraph B, wherein each of the first layshaft and the second layshaft are arranged parallel to the first axis.
D. The gearbox of paragraphs B or C, wherein the first layshaft is arranged along a second axis and the second layshaft is arranged along a third axis, each of the second axis and the third axis being parallel to the first axis.
E. The gearbox of paragraph D, wherein each of the first axis, second axis, and third axis are arranged within a same plane.
F. The gearbox of any one of the preceding paragraphs, wherein a ratio between the input gear and the output gear is 1.2:1.
G. The gearbox of any one of the preceding paragraphs, wherein a maximum allowable twist of at least one of the input shaft, output shaft, first layshaft, or second layshaft is one degree.
H. The gearbox of any one of the preceding paragraphs, wherein a length of each of the first layshaft and the second layshaft is less than a combined length of the input shaft and the output shaft.
I. A generator set drivetrain for a generator configured to couple to an engine, the generator set drivetrain comprising:
   a gearbox structured to transfer power from the engine to the generator, the gearbox comprising:
   an input shaft coupled to an input gear and configured to receive an input power;
   an output shaft coupled to an output gear and configured to transfer an output power;
   a first layshaft and a second layshaft, each of the first layshaft and the second layshaft coupled to a pair of splitter gears, and each of the first layshaft and the second layshaft arranged parallel to both of the input shaft and the output shaft; and
wherein the input power is split between the first layshaft and the second layshaft.
J. The generator set drivetrain of paragraph I, wherein the input shaft is in line with the output shaft.
K. The generator set drivetrain of paragraph J, wherein the first layshaft is disposed on a first side of each of the input shaft and the output shaft, and wherein the second layshaft is disposed on a second side of each of the input shaft and the output shaft, the first side being opposite the second side.
L. The generator set drivetrain of any one of paragraphs I to K, wherein a power received by each of the first layshaft and the second layshaft is between one third and two thirds of the input power.
M. The generator set drivetrain of any one of paragraphs I to L, wherein each of the input shaft, output shaft, first layshaft, and second layshaft are arranged in a same plane.
N. The generator set drivetrain of any one of paragraphs I to M, wherein the input power to output power is 1:1.2.
O. A power transfer assembly comprising:
   a gearbox configured to transfer power, the gearbox comprising:
      an input shaft along a first axis, the input shaft coupled to an input gear; and
      an output shaft arranged along the first axis and spaced from the input shaft, the output shaft coupled to an output gear;
      wherein the input gear is configured to mesh with a first gear mesh, the first gear mesh formed by a first splitter gear and a second splitter gear;
      wherein the output gear is configured to mesh with a second gear mesh, the second gear mesh formed by a first combination gear and a second combination gear; and
      wherein first splitter gear and the first combination gear are coupled to a first shaft and the second splitter gear and the second combination gear are coupled to a second shaft, each of the first shaft and the second shaft being arranged in a same plane as each of the input gear and the output gear.
P. The power transfer assembly of paragraph O, wherein a ratio of the output gear to the input gear is less than 1.5:1.
Q. The power transfer assembly of paragraphs O or P, wherein the input gear and the output gear are respectively coupled to the input shaft and the output shaft via a spline connection.
R. The power transfer assembly of any one of paragraphs O to Q, further comprising a generator set, the generator set including a generator and an engine, wherein the gearbox is structured to transfer power from the engine to the generator.
S. The power transfer assembly of paragraph R, wherein the engine receives a gaseous fuel.
T. A method of producing a generator set, the method comprising:
   coupling an input gear to an input shaft;
   coupling an output gear to an output shaft;
   coupling a first pair of splitter gears to a first layshaft;
   coupling a second pair of splitter gears to a second layshaft;
   arranging the first layshaft relative to the input shaft such that a first of the first pair of splitter gears meshes with the input gear and a second of the first pair of splitter gears meshes with the output shaft;
   arranging the second layshaft relative to the input shaft such that a first of the second pair of splitter gears meshes with the input gear and a second of the second pair of splitter gears meshes with the output gear; and
   arranging the input shaft to be coaxial with the output shaft.
U. The method of paragraph T, wherein:
   coupling the first pair of splitter gears to the first layshaft comprises heat shrinking each of the first pair of splitter gears onto the first layshaft; and
   coupling the second pair of splitter gears to the second layshaft comprises heat shrinking each of the second pair of splitter gears onto the second layshaft.
V. The method of paragraphs T or U, further comprising determining a length to radius ratio for each of the first layshaft and the second layshaft based on a predetermined amount of allowable twist corresponding to each of the first layshaft and the second layshaft.
W. The method of any one of paragraphs T to V, further comprising:
   press fitting a first bearing onto the input shaft; and
   press fitting a second bearing onto the output shaft.
X The method of paragraph W, further comprising:
   press fitting a first pair of bearings onto the first layshaft; and
   press fitting a second pair of bearings onto the second layshaft.
Y. The method of any one of paragraphs T to X, further comprising:
   setting a length of each of the input shaft, output shaft, first layshaft, and second layshaft; and
   determining a radius for each of the input shaft, output shaft, first layshaft, and second layshaft based on a target power load corresponding to each of the input shaft, output shaft, first layshaft, and second layshaft.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A generator set comprising:
an engine;
a generator; and
a gearbox structured to transfer power from the engine to the generator, the generator comprising:
an input shaft coupled to an input gear;
an output shaft coupled to an output gear;
a first layshaft coupled to a first pair of splitter gears, wherein one of the first pair of splitter gears is configured to mesh with the input gear and the other of the first pair of splitter gears is configured to mesh with the output gear; and
a second layshaft coupled to a second pair of splitter gears, wherein one of the second pair of splitter gears is configured to mesh with the input gear and the other of the second pair of splitter gears is configured to mesh with the output gear.

2. The generator set of claim 1, wherein the input shaft and the output shaft are arranged along a first axis, the input shaft being axially spaced from the output shaft.

3. The generator set of claim 2, wherein each of the first layshaft and the second layshaft are arranged parallel to the first axis.

4. The generator set of claim 2, wherein the first layshaft is arranged along a second axis and the second layshaft is arranged along a third axis, each of the second axis and the third axis being parallel to the first axis.

5. The generator set of claim 4, wherein each of the first axis, second axis, and third axis are arranged within a same plane.

6. The generator set of claim 1, wherein a ratio between the input gear and the output gear is less than 1.5:1.

7. The generator set of claim 6, wherein the ratio is less than 0.7:1.

8. A generator set comprising:
a generator;
a drivetrain coupled to the engine, the drivetrain comprising:
a gearbox structured to transfer power from the engine to the generator, the gearbox comprising:
an input shaft coupled to an input gear and configured to receive an input power;
an output shaft coupled to an output gear and configured to transfer an output power;
a first layshaft and a second layshaft, each of the first layshaft and the second layshaft coupled to a pair of splitter gears, and each of the first layshaft and the second layshaft arranged parallel to both of the input shaft and the output shaft; and
wherein the input power is split between the first layshaft and the second layshaft.

9. The generator set of claim 8, wherein the first layshaft is disposed on a first side of each of the input shaft and the output shaft, and wherein the second layshaft is disposed on a second side of each of the input shaft and the output shaft, the first side being opposite the second side.

10. The generator set of claim 8, wherein a power amount received by each of the first layshaft and the second layshaft is between one third and two thirds of the input power.

11. The generator set of claim 8, wherein each of the input shaft, output shaft, first layshaft, and second layshaft are coplanar.

12. The generator set of claim 8, wherein each of the input gear and the output gear are positioned between a pair of support bearings.

13. The generator set of claim 8, further comprising a fluid reservoir, the fluid reservoir comprising one or more conduits to provide a flow of fluid to the generator set.

14. The generator set of claim 8, wherein the engine is configured to receive a gaseous fuel.

15. A method of producing a generator set, the method comprising:
coupling an input gear to an input shaft;
coupling an output gear to an output shaft;
coupling a first pair of splitter gears to a first layshaft;
coupling a second pair of splitter gears to a second layshaft;
arranging the first layshaft relative to the input shaft such that a first of the first pair of splitter gears meshes with the input gear and a second of the first pair of splitter gears meshes with the output shaft;
arranging the second layshaft relative to the input shaft such that a first of the second pair of splitter gears meshes with the input gear and a second of the second pair of splitter gears meshes with the output gear; and
arranging the input shaft to be coaxial with the output shaft.

16. The method of claim 15, wherein:
coupling the first pair of splitter gears to the first layshaft comprises heat shrinking each of the first pair of splitter gears onto the first layshaft; and
coupling the second pair of splitter gears to the second layshaft comprises heat shrinking each of the second pair of splitter gears onto the second layshaft.

17. The method of claim 15, further comprising determining a length to radius ratio for each of the first layshaft and the second layshaft based on a predetermined amount of allowable twist corresponding to each of the first layshaft and the second layshaft.

18. The method of claim 16, further comprising:
press fitting a first bearing onto the input shaft; and
press fitting a second bearing onto the output shaft.

19. The method of claim 18, further comprising:
press fitting a first pair of bearings onto the first layshaft; and
press fitting a second pair of bearings onto the second layshaft.

20. The method of claim 15, further comprising:
setting a length of each of the input shaft, output shaft, first layshaft, and second layshaft; and
determining a radius for each of the input shaft, output shaft, first layshaft, and second layshaft based on a target power load corresponding to each of the input shaft, output shaft, first layshaft, and second layshaft.
